(19) United States
(12) Patent Application Publication
(10) Pub. No.: US 2024/0365397 A1
(43) Pub. Date: Oct. 31, 2024

(54) DEVICE AND METHOD FOR ACQUIRING UPLINK SYNCHRONIZATION IN WIRELESS COMMUNICATION SYSTEM

(71) Applicant: SAMSUNG ELECTRONICS CO., LTD., Suwon-si (KR)

(72) Inventors: Jonghyeuk LEE, Suwon-si (KR); Hyuncheol KIM, Suwon-si (KR)

(21) Appl. No.: 18/767,136

(22) Filed: Jul. 9, 2024

Related U.S. Application Data
(63) Continuation of application No. PCT/KR2022/019297, filed on Nov. 30, 2022.

(30) Foreign Application Priority Data
Jan. 10, 2022 (KR) 10-2022-0003608
Jan. 27, 2022 (KR) 10-2022-0012362

(51) Int. Cl. H04W 74/0833; H04W 56/00; H04W 74/08

(52) U.S. Cl. CPC H04W 74/0833; H04W 56/0045; H04W 74/0866

(57) ABSTRACT

The present disclosure relates to a 5th generation (5G) or pre-5G communication system for supporting a higher data transmission rate beyond a 4th generation (4G) communication system such as long term evolution (LTE). The present disclosure includes a method carried out by a terminal in a wireless communication system. The method may comprise: receiving one or more preambles from a terminal; acquiring correlation values between a plurality of symbol groups corresponding to the one or more preambles; acquiring a timing offset value based on the correlation values, and subcarrier difference information of the plurality of symbol groups; generating uplink timing information based on the timing offset value; and transmitting, to the terminal, a random access response (RAR) including the uplink timing information.

### CROSS-REFERENCE TO RELATED APPLICATIONS

This application is a continuation of International Application No. PCT/KR2022/019297 designating the United States, filed on Nov. 30, 2022, in the Korean Intellectual Property Receiving Office and claiming priority to Korean Patent Application Nos. 10-2022-0003608, filed on Jan. 10, 2022, and 10-2022-0012362, filed on Jan. 27, 2022, in the Korean Intellectual Property Office, the disclosures of each of which are incorporated by reference herein in their entireties.

### BACKGROUND

### Field

The disclosure relates to a device and a method for acquiring uplink synchronization in a wireless communication system.

### Description of Related Art

Efforts have been made to develop improved 5th generation (5G) communication systems or a pre-5G communication systems in order to meet the growing demand for wireless data traffic, since the commercialization of 4th generation (4G) communication systems. For this reason, the 5G communication system or the pre-5G communication system are often referred to as a beyond 4G network communication system or a post LTE (long term evolution) system.

In order to achieve a high data rate, the 5G communication systems are considered to be implemented in ultra-high frequency (mmWave) bands (e.g., 60 GHz band). In order to mitigate the transmission path loss of radio waves in the ultra-high frequency bands and increase the transmission distance of radio waves, beamforming, massive MIMO (multiple-input multiple-output), full dimensional MIMO (FD-MIMO), array antenna, analog beam-forming, and large scale antenna technologies have been discussed in the 5G communication systems.

Further, in order to improve networking of the system, the technologies such as e.g., evolved small cell, advanced small cell, cloud radio access network (cloud RAN), ultra-dense network, device-to-device communication (D2D), wireless backhaul, moving network, cooperative communication, coordinated multi-points (COMP), interference cancellation, or the like have been developed in the 5G communication systems.

In addition, advanced coding modulation (ACM) schemes such as e.g., hybrid frequency shift keying and quadrature amplitude modulation (FQAM) and sliding window superposition coding (SWSC), as well as advanced access techniques such as e.g., filter bank multi carrier (FBMC), non-orthogonal multiple access (NOMA), and sparse code multiple access (SCMA) or the like are being developed for the 5G systems

Narrowband-internet of thing (NB-IoT) systems supporting low power wide area network (LPWAN) may obtain uplink synchronization by means of narrowband physical random access channel (NPRACH) preamble. The NPRACH preambles may support single-tone transmission, in which a symbol group is transmitted in a frequency-hopping scheme. In such a case, a base station may obtain a timing offset for uplink synchronization by means of correlation of neighboring symbol groups. However, it may be difficult for the base station to obtain an accurate timing offset only by the correlation between adjacent symbol groups. Therefore, it is necessary for the base station to also consider the correlation between non-neighboring symbol groups to obtain accurate timing offsets.

### SUMMARY

Embodiments of the disclosure provide a device and a method for obtaining uplink synchronization in a wireless communication system.

Embodiments of the disclosure provide a device and a method for obtaining a timing offset for uplink synchronization based on a correlation between symbol groups and a subcarrier difference between the symbol groups in a wireless communication system.

A method performed by a base station in a wireless communication system according to an example embodiment of the disclosure may include: receiving one or more preambles from a terminal; obtaining correlation values between a plurality of symbol groups corresponding to the one or more preambles; obtaining a timing offset value based on the correlation values and subcarrier difference information for the plurality of symbol groups; generating uplink timing information based on the timing offset value; and transmitting a random access response (RAR) including the uplink timing information to the terminal.

A base station of a wireless communication system according to an example embodiment of the disclosure may include: a transceiver configured to transmit and/or receive a signal and at least one processor, comprising processing circuitry, individually and/or collectively, configured to: control the base station to receive one or more preambles from a terminal; obtain correlation values between a plurality of symbol groups corresponding to the one or more preambles; obtain a timing offset value based on the correlation values and subcarrier difference information for the plurality of symbol groups; generate uplink timing information based on the timing offset value; and control the base station to transmit a random access response (RAR) including the uplink timing information to the terminal.

A method performed by a terminal in a wireless communication system according to an example embodiment of the disclosure may include: transmitting one or more preambles to a base station; receiving a random access response (RAR) including uplink timing information from the base station, wherein the uplink timing information may be based on a timing offset value. The timing offset value may be based on correlation values between a plurality of symbol groups corresponding to the one or more preambles and subcarrier difference information for the plurality of symbol groups.

A terminal of a wireless communication system according to an example embodiment of the disclosure may include: a transceiver configured to transmit and/or receive a signal and at least one processor, comprising processing circuitry, individually and/or collectively, configured to: control the terminal to transmit one or more preambles to a base station; control the terminal to receive a random access response (RAR) including uplink timing information from the base station, wherein the uplink timing information may be based on a timing offset value. The timing offset value may be based on correlation values between a plurality of symbol groups corresponding to the one or more preambles and subcarrier difference information for the plurality of symbol groups. A device and a method according to various example embodiments of the disclosure may obtain uplink synchronization in a wireless communication system.

A device and a method according to various example embodiments of the disclosure may obtain a timing offset for uplink synchronization based on a correlation between symbol groups and a subcarrier difference between the symbol groups.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIGS. 1A, 1B and 1C are diagrams illustrating an example mode in which a narrowband-internet of things (NB-IoT) system is operated according to various embodiments;

FIG. 2 is a signal flow diagram illustrating example random access (RA) in a wireless communication system according to various embodiments;

FIG. 3 is a diagram illustrating example resource allocation of a narrowband physical random access channel (NPRACH) preamble according to various embodiments;

FIG. 4 is a diagram illustrating example resource allocation of an NPRACH preamble according to various embodiments;

FIG. 5 is a flowchart illustrating an example operation of a base station according to various embodiments;

FIG. 6 is a block diagram illustrating an example method for determining a timing offset according to various embodiments;

FIG. 7 is a diagram illustrating an example symbol group correlator block according to various embodiments;

FIG. 8 is a diagram illustrating an example correlation value combiner block according to various embodiments;

FIG. 9 is a diagram illustrating an example timing offset decision block according to various embodiments;

FIG. 10 is a diagram illustrating an example window block for determining a timing offset according to various embodiments;

FIG. 11 is a block diagram illustrating an example configuration of a base station according to various embodiments; and

FIG. 12 is a block diagram illustrating an example configuration of a terminal according to various embodiments.

### DETAILED DESCRIPTION

Hereinafter, the operating principles of the disclosure will be described in greater detail with reference to the accompanying drawings. The terms used in the disclosure are merely used to better describe an embodiment and may not be intended to limit the scope of other embodiments. A singular expression may include a plural expression, unless the context explicitly dictates otherwise. The terms used herein, including technical and scientific terms, may have the same meanings as those commonly understood by those skilled in the art to which the disclosure pertains. Terms defined in a general dictionary amongst the terms used in the disclosure may be interpreted as having the same or similar meaning as those defined in the context of the related art, and they are not to be construed in an ideal or overly formal sense, unless explicitly defined in the disclosure. In some cases, even the terms defined in the disclosure may not be interpreted to exclude embodiments of the disclosure.

Further, throughout the disclosure, an expression such as e.g., ‘more than’ or ‘less than’ may be used to determine whether a specific condition is satisfied or fulfilled, but it is merely of a description for expressing an example and is not intended to exclude the meaning of ‘more than or equal to’ or ‘less than or equal to’. A condition described as ‘more than or equal to’ may be replaced with ‘more than’, a condition described as ‘less than or equal to’ may be replaced with ‘less than’, and a condition described as ‘more than or equal to and less than’ may be replaced with ‘more than and less than or equal to’, respectively.

Further, in the disclosure, embodiments will be described using terms used in various communication standards (e.g., long term evolution (LTE) and new radio (NR) defined in 3rd generation partnership project (3GPP)), but it is only of an example for description. Embodiments of the disclosure may be easily modified and also applied to other communication systems.

Hereinafter, a method and a device for obtaining a timing offset for uplink synchronization by a base station according to various example embodiments of the disclosure will be described in greater detail with reference to the accompanying drawings.

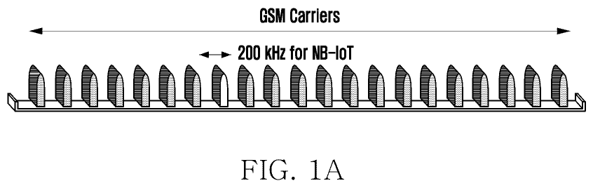

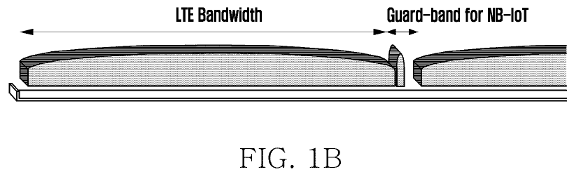

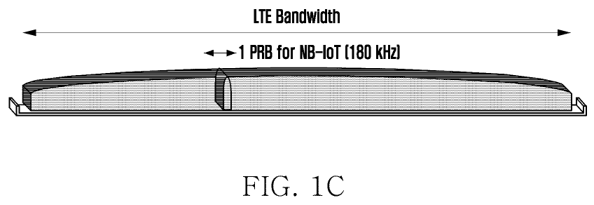

FIGS. 1A, 1B and 1C are diagrams illustrating an example of a mode in which a narrowband-internet of things (NB-IoT) system is operated according to various embodiments.

The NB-IoT system may obtain uplink synchronization through a narrowband physical random access channel (NPRACH) preamble. As an example of a method for obtaining uplink synchronization, a base station may obtain the uplink synchronization by converting a phase offset obtained based on a correlation between NPRACH preambles into a timing offset.

The NPRACH preamble according to embodiments of the disclosure may be transmitted on a single tone. In such a case, the NPRACH preamble may be transmitted in an operation mode of any one of FIGS. 1A, 1B and IC.

As an example, referring to FIG. 1A, the NB-IoT system according to an embodiment of the disclosure may be operated in a standalone mode (e.g., GSM re-farming) to provide NB-IoT, using a GSM frequency band for a global system for mobile telecommunication (GSM) service and a potential frequency band for an IoT service. In this case, one carrier (about 200 kHz band) among GSM carriers may be used as a single tone.

Further, for example, referring to FIG. 1B, the NB-IoT system according to an embodiment of the disclosure may be operated in a guard-band mode to provide the NB-IoT service, using a resource block (RB) that is not used in a guard band defined in a long term evolution (LTE) frequency band. In this case, as illustrated in of FIG. 1B, the carrier in the LTE protection band may be used as a single tone.

Further, for example, referring to FIG. 1C, the NB-IoT system according to an embodiment of the disclosure may be operated in an in-band mode to provide an NB-IoT service using a resource block in an LTE frequency band. In this case, as illustrated in FIG. 1C, one physical resource block (PRB) in the LTE band may be used in a single tone (e.g., 180 kHz).

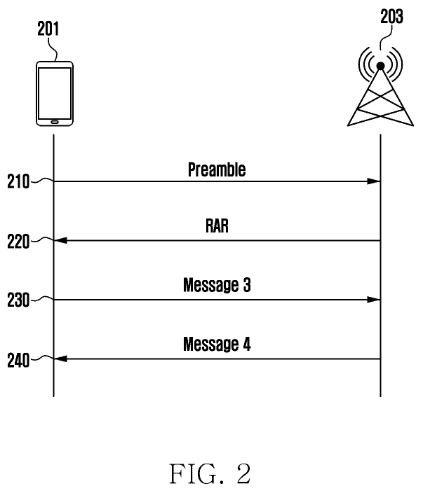

FIG. 2 is a signal flow diagram illustrating example random access in a wireless communication system according to various embodiments. FIG. 2 illustrates a terminal 201 and a base station 203 as a part of nodes of a wireless communication system.

The terminal 201 is a device used by a user and may communicate with the base station 203 over a wireless channel. The terminal 201 may be referred to as a terminal, a user equipment (UE), a mobile station, a subscriber station, a customer premises equipment (CPE), a remote terminal, a wireless terminal, a vehicle terminal, a user device, or any other terms having the same technical meaning as the above.

The base station 203 is a radio access network (RAN) node, serving as a network infrastructure to provide radio access to a terminal. The base station 203 may be referred to as an access point (AP), an eNodeB (eNB), a 5th generation (5G) node, a next generation nodeB (gNB), a wireless point, a transmission and reception point (TRP), or any other terms having the same technical meaning as the above.

Referring to FIG. 2, in operation 210 of an initial access process, the base station 203 may receive a preamble from the terminal. The preamble may correspond to a narrowband physical random access channel (NPRACH) preamble for narrowband-internet of things (NB-IoT). Further, the NPRACH preamble may be repeatedly transmitted on a time domain to improve coverage, and may be transmitted by a hopping manner on a frequency domain. The base station 203 may obtain a timing offset for uplink synchronization based on the received NPRACH preamble. The base station 203 may determine information for uplink synchronization based on the obtained timing offset. The information for uplink synchronization may be a timing advance command (TAC) that is information of a medium access control (MAC) layer.

In operation 220, the base station 203 may transmit a random access response (RAR) to the terminal 201 in response to the preamble. The RAR may include TAC, which is information for uplink synchronization. The terminal 201 may identify a transmission timing of message 3 based on the TAC. In operation 230, the base station 203 may receive the message 3 from the terminal 201. The message 3 may be transmitted at the transmission timing identified by the terminal in operation 220. In operation 240, the base station 203 may transmit message 4 to the terminal 201.

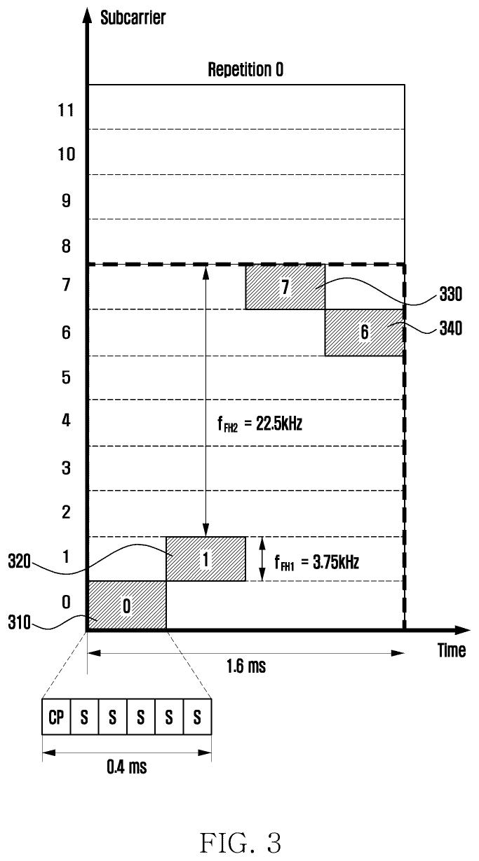

FIG. 3 is a diagram illustrating example resource allocation of an NPRACH preamble according to various embodiments.

The narrowband-internet of things (NB-IoT) system may obtain uplink synchronization through a narrowband physical random access channel (NPRACH) preamble. In such a case, the NPRACH preamble may be repeatedly transmitted on the time domain to improve coverage, and may be transmitted by hopping on the frequency domain. FIG. 3 illustrates an example in which four symbol groups (310, 320, 330, 340) are transmitted in a frequency hopping scheme in one repetition 0. Further, a single tone according to various embodiments of the disclosure may correspond to a single subcarrier.

The terminal may receive configuration information related to transmission of the NPRACH preamble through upper layer signaling (e.g., radio resource control (RRC) layer signaling). For example, the upper layer signaling may be a system information block. The configuration information related to the transmission of the NPRACH preamble may include at least one of information on the start subcarrier of the NPRACH resource, information on the number of subcarriers of the NPRACH resource, information on the NPRACH preamble format, information on the start time of the NPRACH resource, information on the number of repetitions of the NPRACH preamble, information on the NPRACH preamble format, or information on the cycle of the NPRACH resource. FIG. 3 illustrates an example in which an NPRACH resource is set with 12 subcarriers, a transmission cycle of 1.6 ms, and one repetition count, and one symbol group has a length of 0.4 ms. One symbol group may include one cyclic prefix (CP) and five symbols. While FIG. 3 illustrates one subcarrier at 3.75 kHz, it is merely of an example, and the interval of the subcarriers may vary depending upon numerology applied to the terminal.

Referring to FIG. 3, the terminal may transmit the NPRACHs by hopping in the order of subcarriers 0, 1, 7, and 6. In such a case, the base station may obtain a correlation between the NPRACHs received from neighboring symbol groups, using the Equation 1 below:

$$R ( k ) = {\sum }_{a = 0}^{A - 1} \frac{{R}_{a} ( k )}{{σ}_{0 , a}^{2}} \qquad 〈 Equation 1 〉$$

wherein ‘a’ denotes an index of an antenna, and ‘Rₐ(k)’ denotes a correlation value between NPRACHs having k subcarrier intervals in the antenna a. For example, when the NPRACH is transmitted as shown in FIG. 3, ‘Rₐ(1)’ may be a sum of the correlation value of the NPRACHs (310, 320) received on the subcarrier 0 and the subcarrier 1 and the correlation value of the NPRACHs (330, 340) received on the subcarrier 7 and the subcarrier 6.

The base station may convert a phase offset estimated from the correlation value obtained using the Equation 1 into a timing offset through the Equation 2 below:

$$Time\_offset ( k ) = \frac{angle ( R ( k ) )}{Subcarrier\_space \times 2 \times π} \qquad 〈 Equation 2 〉$$

wherein ‘angle(R(k))’ denotes a radian value for a phase angle of the correlation value obtained in the Equation 1. The base station according to embodiments of the disclosure may instruct information on uplink synchronization to the terminal based on the timing offset obtained using the Equation 1 and the Equation 2. For example, the base station may instruct the information on uplink synchronization to the terminal through a timing advance command (TAC) included in a random access response (RAR). As another example, the base station may instruct the information on uplink synchronization to the terminal through the TAC included in a medium access control control element (MAC CE). The terminal may adjust the timing for uplink transmission based on the received information on uplink synchronization.

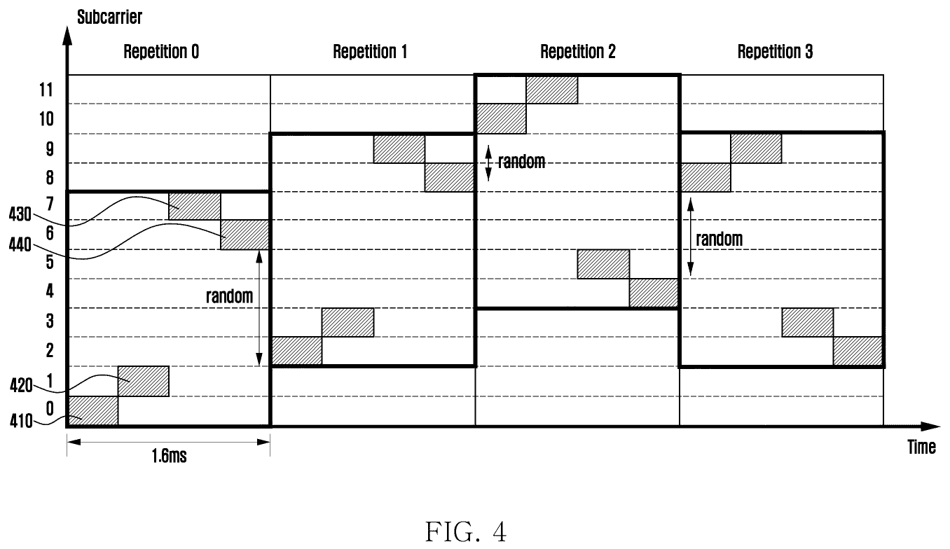

FIG. 4 is a diagram illustrating example resource allocation of an NPRACH preamble according to various embodiments. FIG. 4 illustrates a case where the number of repetitions is set to 4. Referring to FIG. 4, in the first repetition period (repetition 0), the NPRACHs are transmitted hopping in the order of subcarriers 0, 1, 7, and 6. In the second repetition period (repetition 1), the NPRACHs are transmitted hopping in the order of subcarriers 2, 3, 9, and 8. In the third repetition period (repetition 2), the NPRACHs are transmitted hopping in the order of subcarriers 10, 11, 5, and 4. In the fourth repetition period (repetition 3), the NPRACHs are transmitted hopping in the order of subcarriers 8, 9, 3, and 2. The method illustrated in FIG. 4 may be referred to as multi-level frequency hopping.

In the multi-level frequency hopping scheme, hopping applied to transmission of the NPRACHs may be divided into a first level, a second level, and a third level.

The first level of hopping may refer, for example, to hopping applied at one subcarrier interval. For example, referring to the first repetition period (repetition 0) of FIG. 3, the first level of hopping may refer, for example, to hopping between a symbol group transmitted on the subcarrier 0 and a symbol group transmitted on the subcarrier 1. Further, the first level of hopping may refer, for example, to hopping between a symbol group transmitted on the subcarrier 7 and a symbol group transmitted on the subcarrier 6 in the first repetition period (repetition 0). As another example, referring to the second repetition period (repetition 1) of FIG. 3, the first level of hopping may refer, for example, to hopping between a symbol group transmitted on the subcarrier 2 and a symbol group transmitted on the subcarrier 3. Further, the first level of hopping may refer, for example, to hopping between a symbol group transmitted on subcarrier 9 and a symbol group transmitted on the subcarrier 8 in the second repetition period (repetition 1). As another example, referring to the third repetition period (repetition 2) of FIG. 3, the first level of hopping may refer, for example, to hopping between a symbol group transmitted on the subcarrier 10 and a symbol group transmitted on the subcarrier 11. Further, it may refer, for example, to hopping between a symbol group transmitted on the subcarrier 5 and a symbol group transmitted on the subcarrier 4 in the third repetition period (repetition 2) of the first level. As another example, referring to the fourth repetition period (repetition 3) of FIG. 3, the first level of hopping may refer, for example, to hopping between a symbol group transmitted on the subcarrier 8 and a symbol group transmitted on the subcarrier 9. Further, the first level of hopping may refer, for example, to hopping between a symbol group transmitted on the subcarrier 3 and a symbol group transmitted on the subcarrier 2 in the fourth repetition period 3 (repetition 3). Accordingly, in the example illustrated in FIG. 3, the first level of hopping may be performed eight times in total.

The second level of hopping may refer, for example, to hopping applied at six subcarrier intervals. For example, referring to the first repetition period (repetition 0) of FIG. 3, the second level of hopping may refer, for example, to hopping between a symbol group transmitted on the subcarrier 1 and a symbol group transmitted on the subcarrier 7. As another example, referring to the second repetition period (repetition 1) of FIG. 3, the second level of hopping may refer, for example, to hopping between a symbol group transmitted on the subcarrier 3 and a symbol group transmitted on the subcarrier 9. As another example, referring to the third repetition period (repetition 2), the second level of hopping may refer, for example, to hopping between a symbol group transmitted on the subcarrier 11 and a symbol group transmitted on the subcarrier 5. As another example, referring to the fourth repetition period (repetition 3), the second level of hopping may refer, for example, to hopping between a symbol group transmitted on the subcarrier 9 and a symbol group transmitted on the subcarrier 3. Accordingly, the second level of hopping in four repetition periods may be performed four times in total.

The third level of hopping may refer, for example, to hopping applied between repetition periods, and may be referred to as random hopping. For example, referring to FIG. 3, the third level of hopping may refer, for example, to hopping between a symbol group transmitted on the subcarrier 6 of the first repetition period (repetition 0) and a symbol group transmitted on the subcarrier 2 of the second repetition period (repetition 1). In this case, the randomly selected hopping interval may be 4. Further, the third level of hopping may refer, for example, to hopping between a symbol group transmitted on the subcarrier 8 of the second repetition period and a symbol group transmitted on the subcarrier 10 of the third repetition period. In such a case, the randomly selected hopping interval may be 2. Further, the third level of hopping may refer, for example, to hopping between a symbol group transmitted on the subcarrier 4 of the third repetition period and a symbol group transmitted on the subcarrier 8 of the fourth repetition period. In this case, the randomly selected hopping interval may be 4. Accordingly, the third level of hopping in four repetition periods may be performed three times in total.

In case where the base station obtains a timing offset using a correlation between adjacent subcarriers, according to the scheme described with reference to FIG. 4, only the first level of hopping from among the above-described three hopping levels may be applied. In other words, the base station uses only correlation values between adjacent symbol groups, according to a specific subcarrier interval difference (e.g., 1), and thus it may be difficult to obtain an accurate timing offset.

When the correlation information is referred to as is R (k) where the interval between the subcarriers is k, if a machine learning (ML) algorithm is applied, it may be expressed as the following equation.

$${\hat{τ}}_{ml} = {max}_{τ} ( {\sum }_{k = 0}^{K - 1} Power [ {e}^{- j 2 πΔ f τ k} R ( k ) ] ) \qquad 〈 Equation 3 〉$$

Here, the Power operation is a power operation (I²+Q²) for each complex number, and assuming

$$Δ f τ = \frac{m}{M}$$

in the above equation (wherein ‘M’ is an FFT size), the Equation 3 may be expressed as Equation 4 below:

$$\begin{matrix}{\hat{m}}_{ml} = {max}_{m} ( {\sum }_{k = 0}^{M - 1} Power [ {e}^{- j 2 π \frac{m}{M} k} R ( k ) ] ) \\ = {max}_{m} ( {\sum }_{k = 0}^{M - 1} Power [ FFT ( R ( k ) ) ] )\end{matrix} \qquad 〈 Equation 4 〉$$

Accordingly, a method of obtaining a timing offset by considering not only the first hopping level but also the second hopping level and the third hopping level, by simply implementing an ML algorithm using the FFT will be described below.

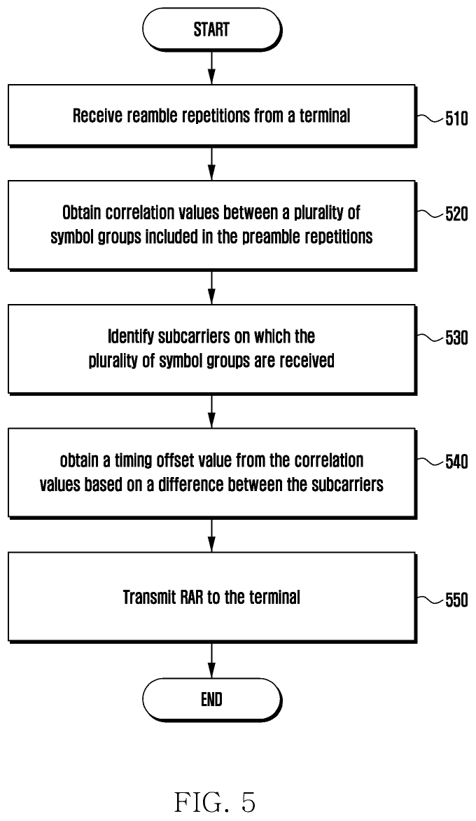

FIG. 5 is a flowchart illustrating an example operation of a base station according to various embodiments. In FIG. 5, an operation of the base station for obtaining an uplink timing offset will be described with reference to resource allocation of a narrowband physical random access channel (NPRACH) preamble of FIG. 4.

In operation 510, the base station may receive preamble repetitions from a terminal. The preamble may be an NPRACH preamble for NB-internet of things (NB-IoT). The NPRACH preamble may be repeatedly transmitted on the time domain to improve coverage, and may be transmitted by hopping on the frequency domain. In this case, the unit in which the NPRACH preamble is repeatedly transmitted may be referred to as a symbol group. The symbol group may include one cyclic prefix (CP) and five symbols. Referring to FIG. 4, it may be indexed as symbol group 0 (e.g., 410 of FIG. 4), symbol group 1 (e.g., 420 of FIG. 4), symbol group 2 (e.g., 430 of FIG. 4), and symbol group 3 (e.g., 440 of FIG. 4). The base station may remove the CP from the symbol group and sum the symbols included in the symbol group (hereinafter, referred to as coherent combining). The coherent combining operation may be expressed as Equation 5 below:

$${y}_{a} [ i ] = {\sum }_{t = 0}^{4} {s}_{i} ( t ) \qquad 〈 Equation 5 〉$$

wherein ‘a’ denotes an antenna index, ‘I’ denotes a symbol group index, and ‘t’ denotes an index of a symbol in a symbol group.

The base station may perform a coherent combining operation for each symbol group. For example, referring to FIG. 4, the base station may perform an operation of coherent combining five symbols of the symbol group 0 (410), which may be expressed as yₐ[0]. Further, the base station may perform an operation of coherent combining five symbols of the symbol group 1 (420), which may be expressed as yₐ[1].

Further, the base station may perform an operation of coherent combining five symbols of symbol group 2 (430), which may be expressed as yₐ[2]. Furthermore, the base station may perform an operation of coherent combining five symbols of the symbol group 3 (440), which may be expressed as yₐ[3]. FIG. 4 illustrates a total of 16 symbol groups, and the base station may perform an operation of coherent combining symbols of each symbol group, wherein a result of coherent combining of an i-th symbol group may be expressed as yₐ[i].

In operation 520, the base station may obtain correlation values between a plurality of symbol groups included in preamble repetitions. After performing the coherent combining operation for each symbol group, the base station may obtain a correlation value between the symbol groups. An operation of obtaining the correlation value between the symbol groups may be expressed as Equation 6 below:

$${R}_{d} [ i ] = {\sum }_{a = 0}^{A - 1} {{y}_{a} [ i ]}^{*} {y}_{a} [ i - d ] \qquad 〈 Equation 6 〉$$

wherein ‘A’ denotes the number of antennas, ‘a’ denotes an antenna index, ‘I’ denotes an index of a symbol group, and ‘d’ denotes an interval between symbol groups.

For example, when A=1, referring to FIG. 4, R₁[1] is a correlation value between the symbol group 0 (410) and the symbol group 1 (420), and may be expressed as R₁[1]=yₐ[1]*yₐ[0], where * means conjugate). Further, R₁[2] is a correlation value between the symbol group 2 (430) and the symbol group 1 (420), and may be expressed as R₁[2]=yₐ[2]*yₐ[1]. In this way, R₂[i] may indicate a correlation between a two symbol group interval, R₃[i] may indicate a correlation between a three symbol group interval, and R₄[i] may indicate a correlation between a four symbol group interval. The correlation value obtained through the above process may have 15 1-symbol group intervals, 14 2-symbol group intervals, 13 3-symbol group intervals, and 12 4-symbol group intervals.

In operation 530, the base station may identify subcarriers on which a plurality of symbol groups are received. The subcarriers may refer to subcarriers in which its symbol group received. For example, referring to FIG. 4, the base station may identify that the symbol group 0 (410) is received on the subcarrier 0, the symbol group 1 (420) is received by the subcarrier 1, the symbol group 3 (430) is received by the subcarrier 7, and the symbol group 4 (440) is received by the subcarrier 6.

In operation 540, the base station may obtain a timing offset value from the correlation values based on a difference between the subcarriers. The difference between the subcarriers may refer to an interval difference between the subcarriers used to calculate the correlation values in operation 520. The base station may classify the correlation values calculated for each symbol group interval based on the interval difference between the subcarriers. For example, when the number of subcarriers allocated through upper layer signaling for NPRACH preamble transmission is 12, there may be 22 interval differences between the subcarriers from −11 to −1 and from 1 to 11. The base station may map the correlation values to 22 inputs (0-10, 12-22) of fast Fourier transform (FFT) inputs, based on the interval difference between the subcarriers. That is, according to the interval difference between the subcarriers, −11 to −1 may be sequentially mapped to 0 to 10 of the input indexes of the FFT, 1 to 11 may be mapped to 12 to 22, and a value of 0 is input to the input index 11 of the FFT. For example, referring to FIG. 4, R₁[3] may be a summed value after calculating a correlation value between the symbol group 3 (440) and the symbol group 2 (430) for each antenna. Here, since the interval difference between the subcarriers used to calculate the correlation value is −1, the base station may map R₁[3] to the input index 10 of the FFT. As another example, referring to FIG. 4, R₂[3] may be a summed value after calculating a correlation value between the symbol group 3 (440) and the symbol group 1 (420) for each antenna. Since the interval difference between the subcarriers used to calculate the correlation value is 5, the base station may map R₂[3] to the input index 16 of the FFT. The base station may perform Fourier transform after setting to zero the remaining FFT input indices except for 0 to 10 and 12 to 22 amongst the input indices of the FFT. After performing the Fourier transform, the base station may set to zero all of the output values of the FFT except for those that are real numbers. Thereafter, the base station may identify a maximum value amongst output values included in a specific window (e.g., a pre-window or a post-window). When the maximum value is identified in the pre-window, a negative delay may be set by applying the FFT index-512. The base station may obtain the timing offset value based on an FFT index and a sampling rate of the identified maximum value. The process of obtaining the timing offset value based on the FFT index and the sampling rate of the identified maximum value may be expressed as Equation 7 below:

$$Timing offset = FFT index having the maximum value / Sampling rate \qquad < Equation 7 >$$

In operation 550, the base station may transmit a random access response (RAR) to the terminal. The RAR may include a timing advance command (TAC) including information on uplink timing. Here, the TAC may be determined based on the timing offset value obtained in operation 540.

As described above, the disclosure is not limited to an adjacent symbol group and one subcarrier interval difference, and therefore, more accurate uplink timing can be obtained using a simple implementation. Hereinafter, each process thereof will be described in greater detail.

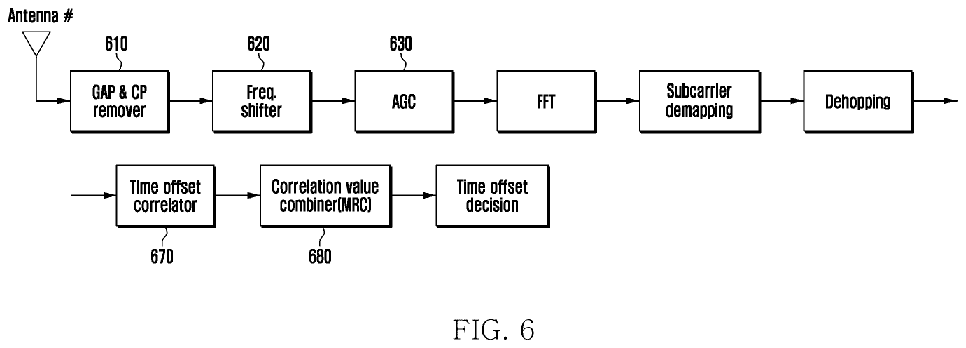

FIG. 6 is a block diagram illustrating an example method for determining a timing offset according to various embodiments. FIG. 6 is a block diagram illustrating an example operation in which a base station receives a narrowband physical random access channel (NPRACH) preamble to estimate an uplink timing offset.

The base station may receive the NPRACH preamble from the antenna. The base station may remove (610) a GAP and a cyclic prefix (CP) included in the NPRACH preamble. As described above, the signal from which the GAP and the CP are removed may be input to a frequency shifter 620 to perform frequency shifting, and may be input to an AGC 630 to be adjusted to a signal included in a predetermined bit area. The signal passing through the AGC 630 may be transmitted as an input of an FFT. An output of the FFT may be demapped to subcarriers used for transmitting the NPRACH preamble. After demapping, the NPRACH preamble transmitted using the same subcarrier may be summed over a symbol group (hereafter, referred to as coherent combining) by dehopping the hopping operation performed. The coherent combining process may be expressed as Equation 5 above.

The base station may perform a coherent combining operation for each symbol group. For example, referring to FIG. 3, the base station may perform an operation of summing five symbols of the symbol group 0 (310) received on the subcarrier 0, which may be expressed as yₐ[0]. Further, the base station may perform an operation of summing five symbols of the symbol group 1 (320) received on the subcarrier 1, which may be expressed as yₐ[1]. Further, the base station may perform an operation of summing five symbols of the symbol group 2 (330) received on the subcarrier 7, which may be expressed as yₐ[2]. Furthermore, the base station may perform an operation of summing five symbols of the symbol group 3 (340) received on the subcarrier 6, which may be expressed as yₐ[3].

The base station may perform a coherent combining operation for each symbol group in the NPRACH repetitions, and then may perform a process of obtaining a correlation value between the symbol groups.

For example, when A=1, referring to FIG. 3, R₁[1] is a correlation value between the symbol group 0 (310) and the symbol group 1 (320), and may be expressed as R₁[1]=yₐ[1]*yₐ[0]. Further, R₁[2] is a correlation value between the symbol group 1 (320) and the symbol group 2 (330), and may be expressed as R₁[2]=yₐ[2]*yₐ[1]. In this way, R₂[i] may indicate a correlation between a two symbol group interval, R₃[i] may indicate a correlation between a three symbol group interval, and R₄[i] may indicate a correlation between a four symbol group interval. The correlation values for each symbol group interval are summed for all receiving antennas and then provided as an input of the correlation value combiner block. R₁[i], R₂[i], R₃[i], and R₄[i] are provided as inputs of the correlation value combiner block. The correlation value combiner block may classify the inputs based on information on a positional difference of the subcarrier and then provide the same as inputs of a timing offset decision block. After performing the FFT of the inputs, the timing offset decision block may calculate the timing offset based on the FFT index and the sampling rate of the maximum value. The timing offset may be calculated based on Equation 7 above.

The base station may obtain a timing advance command (TAC) value based on the calculated timing offset. The base station may transmit a random access response (RAR) including the obtained TAC value to a terminal. The terminal may adjust the timing for uplink transmission based on the received TAC value.

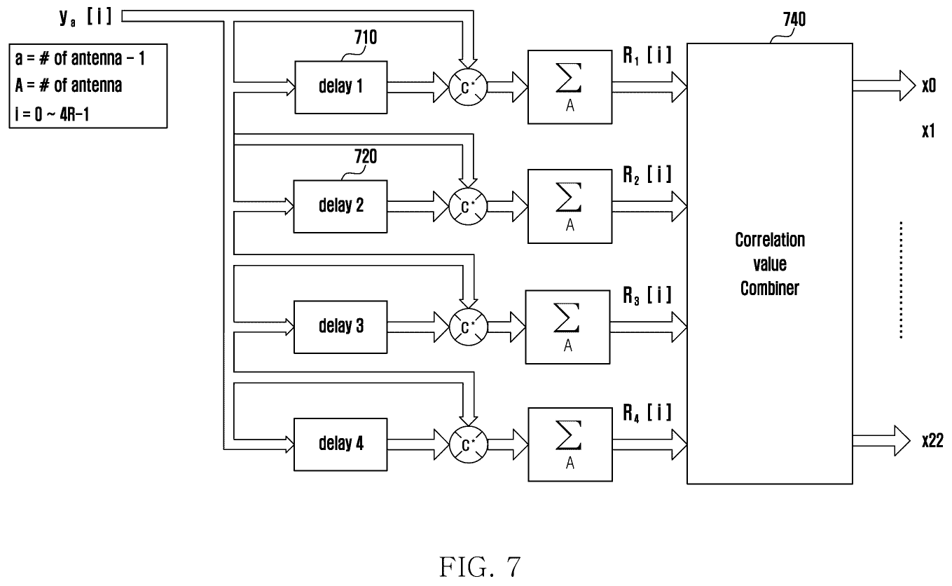

FIG. 7 is a diagram illustrating an example symbol group correlator according to various embodiments. FIG. 7 describes a method of summing correlation values between symbol groups based on a symbol group interval. The symbol group correlator shown in FIG. 7 may include the timing offset correlator 670 and the correlation value combiner 680 shown in FIG. 6.

Referring to FIG. 7, yₐ[i] may be a result of performing a summation operation (hereinafter, referred to as coherent combining) of an i-th symbol group for a narrowband physical random access channel (NPRACH) preamble received through an antenna port a. For example, referring to FIG. 4, yₐ[0] may be the result of coherent combining five symbols of a symbol group 410 received on the subcarrier 0 at the first repetition 0.

The base station may perform an operation of calculating a correlation value for each symbol group interval after performing the coherent combining. For example, delay 1 (710) shown in FIG. 7 may refer to a difference of one symbol group interval. Further, delay 2 (720) may refer to a difference of a two symbol group interval. Furthermore, delay 3 may refer to a difference of a three symbol group interval. Furthermore, delay 4 may refer, for example, to a difference of a four symbol group interval.

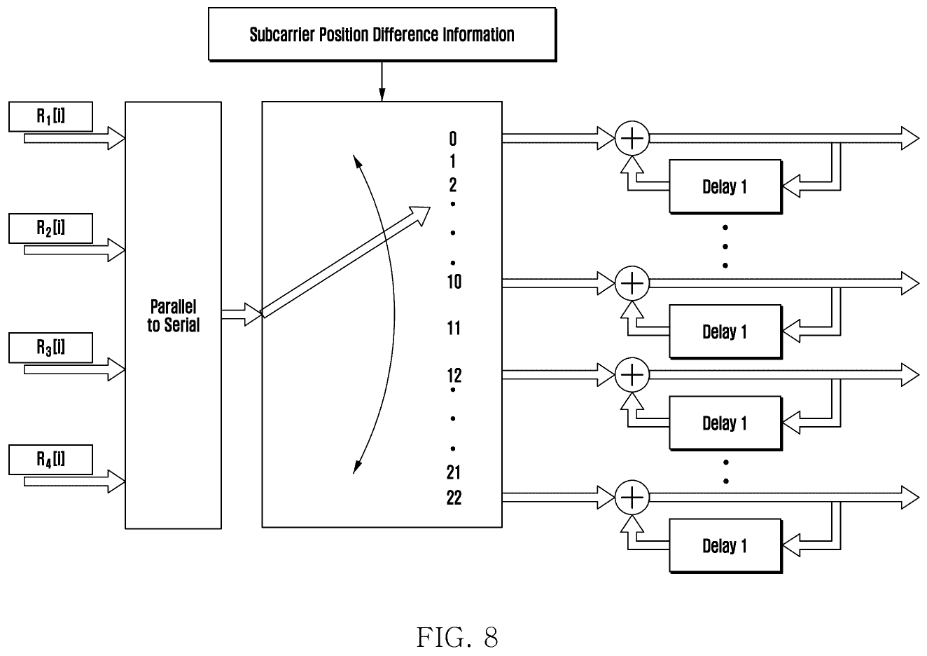

In other words, the base station may calculate and coherent combine correlation values for each symbol group interval for the entirety of A reception antennas. The result of coherent combining the correlation values for one symbol group interval may be expressed as R₁[i]. Further, the result obtained by coherent combining the correlation values for a two symbol group interval may be expressed as R₂[i]. Further, the result obtained by coherent combining the correlation values for a three symbol group interval may be expressed as R₃[i]. Further, the result obtained by coherent combining the correlation values for a four symbol group interval may be expressed as R₄[i]. The correlation values R₁[i], R₂[i], R₃[i], and R₄[i] coherent combined for each symbol group interval may be provided as an input of the correlation value combiner. The correlation value combiner may classify R₁[i], R₂[i], R₃[i], and R₄[i] provided as the input, based on subcarrier position difference information, and then provide the same as an input to the timing offset decision block. An operation of classifying R₁[i], Re [i], R₃[i], and Rₐ[i] according to the correlation value combiner and then providing the classified ones to the timing offset decision block will be described in greater detail below with reference to FIG. 8.

FIG. 8 is a diagram illustrating an example of a correlation value combiner block according to various embodiments. In FIG. 8, an operation performed by the correlation value combiner 740 illustrated in FIG. 7 will be described in greater detail.

Referring to FIG. 8, R₁[i], Re [i], R₃[i], and R₄[i] may be provided as inputs of the correlation value combiner. Rₐ[i] may be a result of coherent combining the correlation values of a symbol group i and another symbol group i-d calculated for each antenna. R₁[i] may correspond to the result of coherent combining the correlation values calculated at one symbol group interval. Further, R₂[i] may correspond to the result of coherent combining the correlation values calculated at a two symbol group interval. Further, R₃[i] may correspond to the result of coherent combining the correlation values calculated at a three symbol group interval. R₄[i] may correspond to the result of coherent combining the correlation values calculated at a four symbol group interval.

The correlation value combiner may classify the result of coherent combining the correlation values based on the subcarrier position difference information. Here, the subcarrier position difference information may refer to subcarrier intervals (e.g., −11 to −1, 1 to 11) used in the process of calculating the correlation value, and the result obtained by coherent combining of the correlation values may be classified into 22 types (e.g., 0 to 10, 12 to 22). In other words, the subcarriers intervals (−11 to −1,1 to 11) may be mapped to outputs (e.g., 0 to 10, 12 to 22) of the correlation value combiner. For example, referring to FIG. 4, R₁[3] may be a value obtained by coherent combining, after calculating for each antenna a correlation value between the NPRACH symbol group received on the subcarrier 6 and the NPRACH symbol group received on the subcarrier 7. Since the subcarrier interval used to calculate the correlation value is −1, the correlation value combiner may connect R₁[3] to an output 10. As another example, referring to FIG. 4, R₂[3] may be a value coherent combined after calculating for each antenna a correlation value between the NPRACH symbol group received on the subcarrier 6 and the NPRACH symbol group received on the subcarrier 1. Since the interval of the subcarrier used to calculate the correlation value is 5, the correlation value combiner may connect R₂[3] to an output 16.

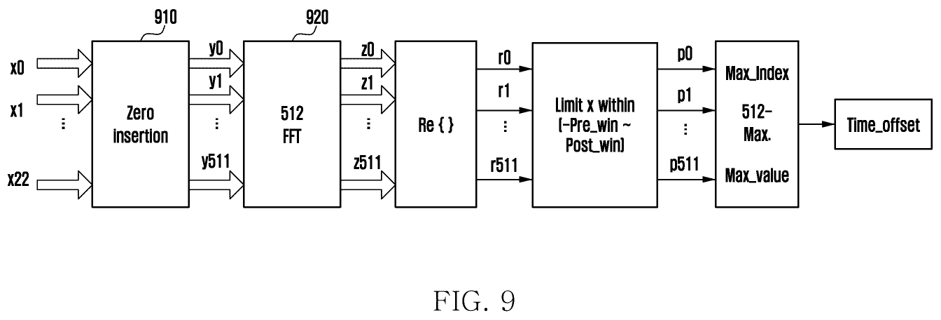

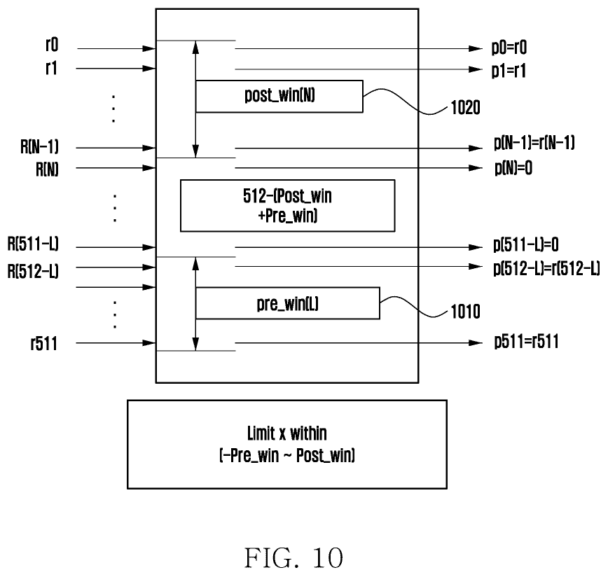

The result classified as described above may be provided as an input to the timing offset decision block. The operation of the timing offset decision block will be described in greater detail below with reference to FIGS. 9 and 10.

Hereinafter, a method of obtaining information for timing offset and uplink synchronization from a phase offset according to embodiments of the disclosure will be described in greater detail below with reference to FIGS. 9 and 10.

FIG. 9 is a diagram illustrating an example timing offset decision block according to various embodiments, and FIG. 10 is a diagram illustrating an example window block for determining a timing offset according to various embodiments.

Referring to FIG. 9, the result (x1, x2, . . . , x22) of classification according to the method described in FIG. 8 may be provided as an input to a timing offset decision block. For example, when Fast Fourier Transform (FFT) having a size of 512 is used, as illustrated in FIG. 9, 23 correlation coupler outputs (x0, x2, . . . , x22) are sequentially transmitted as an input of the FFT, and the remaining FFT inputs (index 11 and 23 to 511) are input as 0 (910). Since the index 11 may refer, for example, to the interval of the subcarrier (e.g., hopping interval) being 0, it is input as 0.

The timing offset decision block may insert the zero bit 0 and then perform a Fourier transform (920) based on corresponding outputs (y0, y1, . . . , y511), thereby outputting resultant values (20, z1, . . . , z511) through 512 output terminals.

The values (z0, z1, . . . , z511) output from the FFT may be output (r0, r1, . . . , r511) after performing a power operation (I\hat{ }2+Q\hat{ }2).

The timing offset decision block may output values (p0, p1, . . . , p511) that overwrite with zeros those values that do not fall within a certain window range for the values (r0, r1, . . . , r511) output by the FFT, corresponding to real numbers. For example, referring to FIG. 10, a pre-window range 1010 and a post-window range 1020 may be set. A sum of the pre-window range 1010 and the post-window range 1020 is less than or equal to the FFT size (e.g., 512). The timing offset decision block may perform an operation to overwrite values that do not fall within the above-described ranges with zeros.

The timing offset decision block may identify a maximum value within the window range (1010, 1020) among the output values (p0, p1, . . . , p511). When the selected maximum value is selected within the pre-window, the FFT index 512 may be applied to make sure that it is a negative delay. The timing offset decision block may determine the timing offset by applying the Equation 7 to the FFT index of the identified maximum value.

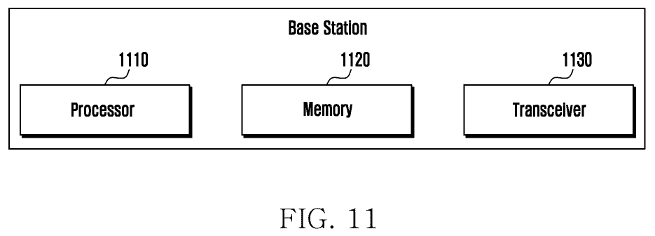

FIG. 11 is a block diagram illustrating an example configuration of a base station according to various embodiments. Referring to FIG. 11, the base station may include a processor (e.g., including processing circuitry) 1110, a memory 1120, and a transceiver 1130.

The processor 1110 may include various processing circuitry and control the overall operation of the base station. For example, the processor 1110 may transmit and receive a signal through the transceiver 1130. In addition, the processor 1110 may perform functions of a protocol stack required by the communication standard. To this end, the processor 1110 may include at least one processor. Further, the processor 1110 may control the base station to perform the operations according to the above-described embodiments. The processor 1110 may, according to various embodiments, include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The memory 1120 may store data such as a basic program, an application program, and configuration information, for operating the base station. The memory 1120 may include a volatile memory, a non-volatile memory, or a combination of the volatile memory and the non-volatile memory. The memory 1120 may provide stored data according to a request of the processor 1110.

The transceiver 1130 may perform functions for transmitting and receiving signals through a wired channel or a wireless channel. For example, the transceiver 1130 may perform a conversion function between a baseband signal and a bit string according to the physical layer standard of the system. For example, upon data transmission, the transceiver 1130 may generate complex symbols by encoding and modulating a transmission bit string. Further, upon data reception, the transceiver 1130 may restore the baseband signal to the received bit string by demodulation and decoding. In addition, the transceiver 1130 may up-convert the baseband signal into a radio frequency (RF) band signal, transmit the RF band signal through an antenna, and down-convert an RF band signal received through the antenna into a baseband signal. To this end, the transceiver 1130 may include a transmission filter, a reception filter, an amplifier, a mixer, an oscillator, a digital-to-analog converter (DAC), an analog-to-digital converter (ADC), or the like. Further, the transceiver 1130 may include an antenna. The transceiver 1130 may include at least one antenna array including a plurality of antenna elements. In terms of hardware, the transceiver 1130 may be configured as a digital and analog circuit (e.g., radio frequency integrated circuit, RFIC)). Here, the digital and analog circuits may be implemented as one package. Further, the transceiver 1130 may include a plurality of RF chains. Further, the transceiver 1130 may transmit and receive a signal. To this end, the transceiver 1130 may include at least one transceiver.

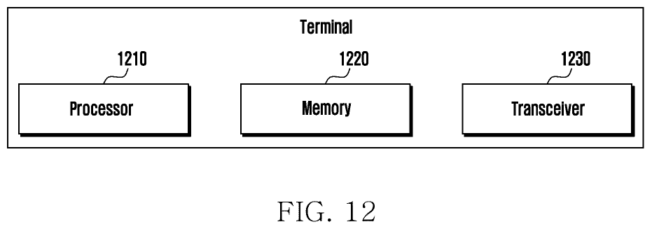

FIG. 12 is a block diagram illustrating an example configuration of a terminal according to various embodiments. Referring to FIG. 12, a terminal may include a processor (e.g., including processing circuitry) 1210, a memory 1220, and a transceiver 1230.

The processor 1210 may include various processing circuitry and control the overall operation of the terminal. For example, the processor 1210 may transmit and receive a signal through the transceiver 1230. Further, the processor 1210 may perform functions of a protocol stack required by the communication standard. To this end, the processor 1210 may include at least one processor. Further, the processor 1210 may control the terminal to perform the operations according to the above-described embodiments. The processor 1210 according to various embodiments, may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The memory 1220 may store data such as a basic program, an application program, and configuration information, for operation of the terminal. The memory 1120 may include a volatile memory, a non-volatile memory, or a combination of the volatile memory and the non-volatile memory. The memory 1220 may provide stored data according to a request of the processor 1210.

The transceiver 1230 may perform functions for transmitting and receiving signals through a wired channel or a wireless channel. For example, the transceiver 1230 may perform a conversion function between a baseband signal and a bit string according to a physical layer standard of the system. For example, during data transmission, the transceiver 1230 may generate complex symbols by encoding and modulating the transmission bit string. Further, upon data reception, the transceiver 1230 may restore the baseband signal to the received bit string by demodulation and decoding. In addition, the transceiver 1230 may up-convert the baseband signal into a radio frequency (RF) band signal to transmit the RF band signal through an antenna, and down-convert an RF band signal received through the antenna into a baseband signal. To this end, the transceiver 1230 may include a transmission filter, a reception filter, an amplifier, a mixer, an oscillator, a digital-to-analog converter (DAC), an analog-to-digital converter (ADC), or the like. Further, the transceiver 1130 may include an antenna unit. The transceiver 1230 may include at least one antenna array including a plurality of antenna elements. In terms of hardware, the transceiver 1230 may be configured as a digital and analog circuit (e.g., a radio frequency integrated circuit, RFIC). Here, the digital and analog circuits may be implemented as one package. Further, the transceiver 1130 may include a plurality of RF chains. Furthermore, the transceiver 1230 may transmit and receive a signal. To this end, the transceiver 1230 may include at least one transceiver.

According to an embodiment, a base station of a wireless communication system, the base station comprises a transceiver configured to transmit and/or receive signals, memory comprising one or more media, storing instructions, and at least one processor comprising processing circuitry. The instructions, when executed by the at least one processor individually or collectively, cause the base station to receive one or more preambles from a terminal, obtain correlation values between a plurality of symbol groups corresponding to the one or more preambles, obtain a timing offset value, based on the correlation values and subcarrier difference information for the plurality of symbol groups, generate uplink timing information based on the timing offset value, and transmit a random access response (RAR) including the uplink timing information to the terminal.

According to an embodiment, symbols included in the plurality of symbol groups are coherent combined according to indexes of the plurality of symbol groups. The correlation values are obtained based on a difference between the indexes of the plurality of symbol groups.

According to an embodiment, the instructions, when executed by the at least one processor individually or collectively, cause the base station to determine indexes of the correlation values based on a subcarrier difference value between the plurality of symbol groups, perform fast Fourier transform (FFT) based on the indexes of the correlation values, and obtain a timing offset value based on a result of performing the FFT and a sampling rate.

According to an embodiment, the instructions, when executed by the at least one processor individually or collectively, cause the base station to identify a number of subcarriers allocated to the one or more preambles, and determine the indexes for the correlation values, based on the number of subcarriers.

According to an embodiment, the instructions, when executed by the at least one processor individually or collectively, cause the base station to: identify a maximum value among output values of the FFT, identify a window including an FFT index corresponding to the identified maximum value, obtain the timing offset based on the FFT index, based on the identified window being a first window; and obtain the timing offset based on a value obtained by subtracting a size of the FFT from the FFT index, based on the identified window being a second window.

According to an embodiment, a terminal of wireless communication system, comprises a transceiver configured to transmit and/or receive signals, memory comprising one or more media, storing instructions, and at least one processor comprising processing circuitry. The instructions, when executed by the at least one processor individually or collectively, cause the terminal to transmit one or more preambles to a base station, and receive, from the base station, a random access response (RAR) including uplink timing information. The uplink timing information is based on a timing offset value. The timing offset value is based on correlation values between a plurality of symbol groups corresponding to the one or more preambles and subcarrier difference information for the plurality of symbol groups.

According to an embodiment, symbols included in the plurality of symbol groups are coherent combined based on indexes of the plurality of symbol groups. The correlation values are obtained based on a difference between the indexes of the plurality of symbol groups.

According to an embodiment, the instructions, when executed by the at least one processor individually or collectively, cause the terminal to transmit, based on the uplink timing information, a message 3 to the base station. The uplink timing information corresponds to a timing advance command (TAC).

According to an embodiment, the timing offset value is obtained based on a result of performing fast Fourier transform (FFT) and a sampling rate. The FFT is performed based on indexes of the correlation values. The indexes of the correlation values are determined based on a subcarrier difference value between the plurality of symbol groups.

According to an embodiment, the instructions, when executed by the at least one processor individually or collectively, cause the terminal to receive, from the base station, information on a number of subcarriers allocated to the one or more preambles through higher layer signaling. The indexes for the correlation values are determined based on the number of subcarriers.

It should be appreciated that various embodiments of the disclosure and the terms used herein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B”, “at least one of A and B”, “at least one of A or B”, “A, B, or C”, “at least one of A, B, and C”, and “at least one of A, B, or C” may include any one of, or all possible combinations of the items enumerated together in a corresponding one of the phrases. As used herein, such terms as “1st” and “2nd”, or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with”, “coupled to”, “connected with”, or “connected to” another element (e.g., a second element), the element may be coupled with the other element directly (e.g., wiredly), wirelessly, or via a third element.

The methods according to various embodiments described in the claims or the disclosure may be implemented in hardware, software, or a combination of hardware and software.

When implemented by software, a computer-readable storage medium storing one or more programs (software modules) may be provided. One or more programs stored in a computer-readable storage medium are configured for execution by one or more processors in an electronic device. One or more programs include instructions for causing an electronic device to execute methods according to the claims of the present disclosure or the various embodiments described in the disclosure.

These programs (software modules or software) may be stored in a random access memory, a non-volatile memory including a flash memory, a read only memory (ROM), an electrically erasable programmable read only memory (EEPROM), a magnetic disc storage device, a compact disc-ROM (CR-ROM), digital versatile discs (DVDs) or other types of optical storage devices, or magnetic cassettes. Alternatively, it may be stored in a memory configured by any combination of some or all of them. Further, each of that configured memories may comprise a plurality of those memories.

In addition, the program may be stored in an attachable storage device accessible through a communication network such as the Internet, an intranet, a local area network (LAN), a wide area network (WAN), or a storage area network (SAN), or a communication network configured by combining the networks. Such a storage device may access a device performing an embodiment of the disclosure through an external port. Further, a separate storage device on the communication network may access a device performing an embodiment of the disclosure.

In the above-described various example embodiments of the disclosure, components included in the disclosure are expressed in a singular or plural form according to the presented example embodiments. However, the singular form or plural form is selected appropriately for the presented situation for the convenience of description, and the disclosure is not limited to the singular form or the plural form. Further, either a component represented in the plural may be configured as a single element, or a component represented in the singular may be configured as a plurality of elements.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

No claim element is to be construed under the provisions of 35 U.S.C. § 112, sixth paragraph, unless the element is expressly recited using the phrase “means for” or “means.”

What is claimed is:

1. A method performed by a base station in a wireless communication system, the method comprising:
receiving one or more preambles from a terminal;
obtaining correlation values between a plurality of symbol groups corresponding to the one or more preambles;
obtaining a timing offset value based on the correlation values and subcarrier difference information for the plurality of symbol groups;
generating uplink timing information based on the timing offset value; and
transmitting a random access response (RAR) including the uplink timing information to the terminal.

2. The method of claim 1,
wherein symbols included in the plurality of symbol groups are coherent combined based on indexes of the plurality of symbol groups, and
wherein the correlation values are obtained based on a difference between the indexes of the plurality of symbol groups.

3. The method of claim 1, wherein the obtaining the timing offset value further comprises:
determining the indexes of the correlation values based on subcarrier difference value between the plurality of symbol groups;
performing Fast Fourier Transform (FFT) based on the indexes of the correlation values; and
obtaining the timing offset value based on a result of performing the FFT and a sampling rate.

4. The method of claim 1, further comprising:
identifying a number of subcarriers allocated to the one or more preambles; and
determining the indexes of the correlation values, based on the number of subcarriers.

5. The method of claim 3, wherein the obtaining of the timing offset value further comprises:
identifying a maximum value among output values of the FFT;
identifying a window including an FFT index corresponding to the identified maximum value;
obtaining the timing offset based on the FFT index based on the identified window being a first window; and
obtaining the timing offset based on a value obtained by subtracting a size of the FFT from the FFT index, based on the identified window being a second window.

6. A base station of a wireless communication system, the base station comprising:
a transceiver configured to transmit and/or receive signals;
memory comprising one or more media, storing instructions; and
at least one processor comprising processing circuitry;
wherein the instructions, when executed by the at least one processor individually or collectively, cause the base station to:
receive one or more preambles from a terminal,
obtain correlation values between a plurality of symbol groups corresponding to the one or more preambles,
obtain a timing offset value, based on the correlation values and subcarrier difference information for the plurality of symbol groups,
generate uplink timing information based on the timing offset value, and
transmit a random access response (RAR) including the uplink timing information to the terminal.

7. The base station of claim 6,
wherein symbols included in the plurality of symbol groups are coherent combined according to indexes of the plurality of symbol groups, and
wherein the correlation values are obtained based on a difference between the indexes of the plurality of symbol groups.

8. The base station of claim 6, wherein the instructions, when executed by the at least one processor individually or collectively, cause the base station to:
determine indexes of the correlation values based on a subcarrier difference value between the plurality of symbol groups,
perform fast Fourier transform (FFT) based on the indexes of the correlation values, and
obtain a timing offset value based on a result of performing the FFT and a sampling rate.

9. The base station of claim 6, wherein the instructions, when executed by the at least one processor individually or collectively, cause the base station to:
identify a number of subcarriers allocated to the one or more preambles, and
determine the indexes for the correlation values, based on the number of subcarriers.

10. The base station of claim 8, wherein the instructions, when executed by the at least one processor individually or collectively, cause the base station to:
identify a maximum value among output values of the FFT,
identify a window including an FFT index corresponding to the identified maximum value,
obtain the timing offset based on the FFT index, based on the identified window being a first window; and
obtain the timing offset based on a value obtained by subtracting a size of the FFT from the FFT index, based on the identified window being a second window.

11. A method performed by a terminal in a wireless communication system, the method comprising:
transmitting one or more preambles to a base station; and
receiving a random access response (RAR) including uplink timing information from a base station,
wherein the uplink timing information is based on a timing offset value,
wherein the timing offset value is based on correlation values between a plurality of symbol groups corresponding to the one or more preambles and subcarrier difference information for the plurality of symbol groups.

12. The method of claim 11,
wherein symbols included in the plurality of symbol groups are coherent combined based on indexes of the plurality of symbol groups, and
wherein the correlation values are obtained based on a difference between the indexes of the plurality of symbol groups.

13. The method of claim 11, further comprising transmitting message 3 to the base station based on the uplink timing information,
wherein the uplink timing information corresponds to a timing advance command (TAC).

14. The method of claim 11,
wherein the timing offset value is obtained based on a result of performing fast Fourier transform (FFT) and a sampling rate,
wherein the FFT is performed based on indexes of the correlation values, and
wherein the indexes of the correlation values are determined based on a subcarrier difference value between the plurality of symbol groups.

15. The method of claim 11, further comprising receiving, from the base station, information on a number of subcarriers allocated to the one or more preambles through higher layer signaling,
wherein the indexes for the correlation values are determined based on the number of subcarriers.

16. A terminal of wireless communication system, the terminal comprising:
a transceiver configured to transmit and/or receive signals;
memory comprising one or more media, storing instructions; and
at least one processor comprising processing circuitry;
wherein the instructions, when executed by the at least one processor individually or collectively, cause the terminal to:
transmit one or more preambles to a base station, and
receive, from the base station, a random access response (RAR) including uplink timing information,
wherein the uplink timing information is based on a timing offset value,
wherein the timing offset value is based on correlation values between a plurality of symbol groups corresponding to the one or more preambles and subcarrier difference information for the plurality of symbol groups.

17. The terminal of claim 16, wherein symbols included in the plurality of symbol groups are coherent combined based on indexes of the plurality of symbol groups, and
wherein the correlation values are obtained based on a difference between the indexes of the plurality of symbol groups.

18. The terminal of claim 16 wherein the instructions, when executed by the at least one processor individually or collectively, cause the terminal to transmit, based on the uplink timing information, a message 3 to the base station, and
wherein the uplink timing information corresponds to a timing advance command (TAC).

19. The terminal of claim 16, wherein the timing offset value is obtained based on a result of performing fast Fourier transform (FFT) and a sampling rate,
wherein the FFT is performed based on indexes of the correlation values, and
wherein the indexes of the correlation values are determined based on a subcarrier difference value between the plurality of symbol groups.

20. The terminal of claim 16, wherein the instructions, when executed by the at least one processor individually or collectively, cause the terminal to receive, from the base station, information on a number of subcarriers allocated to the one or more preambles through higher layer signaling, and
wherein the indexes for the correlation values are determined based on the number of subcarriers.
